(19) United States
(12) Patent Application Publication
(10) Pub. No.: US 2009/0295303 A1
(43) Pub. Date: Dec. 3, 2009

(54) BRIGHTNESS CONTROL OF FLUORESCENT LAMPS

(76) Inventors: Andrzej Pucko, Torun (PL); Anthony James Doyle, Horsham (GB)

Correspondence Address: COOPER & DUNHAM, LLP, 30 Rockefeller Plaza, 20th Floor, NEW YORK, NY, 10112, US

(21) Appl. No.: 11/919,405

(22) PCT Filed: Apr. 19, 2006
(86) PCT No.: PCT/GB2006/001409

§ 371 Date: Jul. 2, 2009

(30) Foreign Application Priority Data
Apr. 25, 2005 (GB) 0508246.6

(51) Int. Cl. H05B 41/24

(52) U.S. Cl. 315/246

(57) ABSTRACT

A method of controlling the brightness of a fluorescent lamp from a low frequency alternating current mains supply is described in which the lamp has an associated ballast providing a higher frequency power supply. The ballast includes a microprocessor which controls the frequency of the power supplied to the lamp by the ballast. This frequency is varied in accordance with the desires of the operator by actuating a cycle of variation of the frequency supplied to the lamp and ending the cycle when the desired brightness is reached. The cycle of variation of the frequency may be initiated by operation of a control switch located in series with the mains supply such as an on/off switch; the cycle of variation of the frequency is initiated by momentary operation of the control switch. In an alternative embodiment the control switch is a dimmer switch which suppresses part of each cycle of the mains supply and the variation of the frequency is initiated by the control switch. In a further embodiment the cycle of variation of the frequency is initiated by an external radiated signal received by the microprocessor, such as an infrared signal directed to an IR sensor located in the ballast or a radio frequency signal directed to a radio-receiver incorporated in the ballast. The fluorescent tube may be detachably fitted to a ballast unit which forms part of the lamp base. There is also provided a fluorescent lamp ballast for use in the described method comprising a microprocessor which controls the frequency of the power supplied to the lamp by the ballast and which is varied in accordance with the desires of the operator by actuating a cycle of variation of the frequency supplied to the lamp and ending the cycle when the desired brightness is reached.

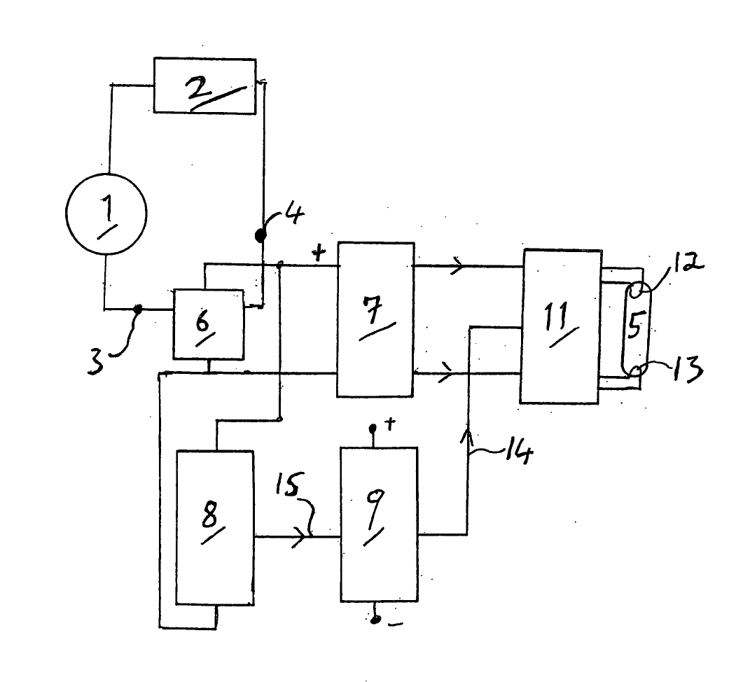

This invention relates to an improved method of controlling the brightness of fluorescent lamps and apparatus for operating the method.

Control of the brightness of electric lamps supplied from alternating current mains requires the amount of energy supplied to the illumination source to be controlled. Incandescent lamps, in which the illumination source is a heated filament, behave as a purely resistive load so that control of the brightness is easily obtained by controlling the energy supplied to the lamp. This is commonly achieved by using so-called dimmer switches in which part of each cycle of the supply source sine wave is suppressed either at the leading or the trailing edge.

Fluorescent lamps have a considerably greater luminous efficiency than incandescent lamps; the light source is a gas or vapour in a tube which is excited by the passage of an electric current. The excited gas emits radiation which causes a fluorescent coating inside the tube to emit visible light. The supply to the light source involves a heated filament excitation system and a ballast, often an inductor, to limit the current flowing through the light source which does not behave as a resistive load.

Control of the brightness of fluorescent lamps is possible but generally requires complex circuitry and extra leads to the lamp ballast. The present invention provides a ballast system for fluorescent lamps which permits a standard series connected dimmer switch to be used. The present invention also provides a ballast system for brightness control of fluorescent lamps which permits a standard series connected switch to used. The ballast system may be integral with the fluorescent tube holder, as in so-called integral compact fluorescent lamps (iCFLs) or as a module contained in a separate unit into which the tube is inserted. The latter form is preferred as the potential life of the ballast system is far greater that that of the tube.

According to the present invention there is provided a method of controlling the brightness of a fluorescent lamp from a low frequency alternating current mains supply in which the lamp has an associated ballast providing a higher frequency power supply, characterised in that the ballast includes a microprocessor which controls the frequency of the power supplied to the lamp by the ballast and which is varied in accordance with the desires of the operator by actuating a cycle of variation of the frequency supplied to the lamp and ending the cycle when the desired brightness is reached.

In one embodiment the invention provides a method of controlling the brightness of a compact fluorescent lamp from an alternating current source using a switch and the frequency of the power supplied to the lamp is varied in accordance to desires of the operator, either by actuating a cycle of variable frequency supplied to the lamp, internally generated in the ballast but initiated by the switch, then stopping the cycle with the switch when the desired brightness is reached, or by changing the frequency of power supplied to the lamp by means of an external signal such as an infrared signal to an IR sensor incorporated in the ballast or a radio-frequency signal to a radio-receiver incorporated in the ballast.

In its preferred form the method requires a control signal to be derived either from the suppressed portion of each cycle, or from an IR or RF transmitter, or from initiation from a standard on/off series connected switch, processing means adapted to provide a variable frequency signal either related to the amount of each cycle suppressed, or to the duration of the IR or RF signal, or to the duration of the switch-initiation cycle, and a variable frequency power source which supplies the filaments and cathodes of a compact fluorescent lamp.

In order that the invention may be clearly understood it will now be described with reference to the accompanying FIGURE showing the major circuit elements in block form. The control from a power suppressing dimmer switch contains the most circuit elements and will be described first.

In the control from a series connected dimmer switch, an alternating current source, usually 110 or 230 volts rms at 50 to 60 Hz 1 is connected in series with a cycle suppression dimmer 2 to the input terminals 3 and 4 of a ballast system connected to a fluorescent lamp 5.

The first component of the ballast system, is a bridge rectifier 6 which provides a unipolar pulsating voltage to a power factor correction unit 7 and an active load circuit, 8. A reduced level and stabilised supply (not shown) is also powered by the output from the bridge and supplies a microprocessor control circuit 9.

The power factor correction unit 7 also supplies a boosted direct voltage supply to a variable frequency power supply 11. The supply 11 provides power to filaments 12 and 13 of the lamp 5. The filaments 12 and 13 also form the cathodes of the lamp 5 when supplied by a high frequency electrical source, e.g. 25 to 100 kHz, having a voltage sufficient to cause a discharge between these electrodes. The supply 11 has a control input 14 which controls the frequency of the power providing the discharge in the lamp 5.

The active load circuit 8 receives the pulsating supply waveform from the bridge 6 and in one embodiment provides a signal 15 proportional to the suppressed angle of the waveform. Preferably the proportionality is in the time domain output as a series of variable duration pulses.

The output 15 from the circuit 8 is passed to the control circuit 9 where, in conjunction with ancillary circuit elements, it is converted to a frequency signal whose frequency is designed to interact with the resonance circuit in series with the lamp such that the impedance of this circuit allows the particular current to be passed between the electrodes of the lamp to create the level of illumination that would have been supplied through the dimmer 2 were it to be connected to an incandescent lamp.

In order to maintain steady brightness regardless of mains supply the current through the lamp is monitored and the supply ballast supply frequency circuit 9 programmed to vary so as to produce the desired brightness knowing the characteristics of the tube.

A cycle of variable frequency is produced by the microprocessor control circuit 9, alone or in conjunction with ancillary circuit elements, in response to an external stimulation. This may be provided by the input from a dimmer switch in accordance with the time on/time off of the mains 50 or 60 Hz cycle by initiation of a cycling change in pulse width provided by the microprocessor, which is subsequently converted to a cycling frequency either by discrete circuit components or by components found inside proprietary fluorescent lamp electronic ballast “driver chips”, or by initiation of a cycling change in frequency provided by the microprocessor control circuit 9. Alternatively this cycling is created within the microprocessor by the microprocessor in response to a stimulation a) by momentary interruption of the power by switching off, then on with an ordinary switch, then switching off again when the desired brightness is reached or b) by an IR signal from an IR detector incorporated in the ballast or c) by an RF signal from a receiver incorporated in the ballast.

When the invention is used in conjunction with an on/off switch in a conventional lighting circuit the circuitry becomes simpler. The power factor correction 7 is not required to extend the power available to heat the filaments or maintain the voltage to the electrodes during the period that a dimmer switch interrupts the power. Also the active load circuit 8 is not required to convert the periodicity of time on to time off of power flowing from the dimmer switch. With an on/off switch power is flowing constantly when the switch is on. Instead of these components the control circuit 9 can be adapted to change the control frequency 14 in response to different signals.

In the case of the switch only system, without the IR or RF signaling, the control circuit 9 can be induced into producing a cyclical change to the frequency 14 for example by momentarily interrupting the power to the circuitry by switching the lamp rapidly off and on again. This results in a cycling of the lamp brightness, which can be stopped by the operator at the desired brightness by interrupting the power again. Switching on the power subsequently will result in the previously determined frequency 14 to be supplied to the variable frequency power supply 11. Alternatively the cycling of the frequency 14 can be induced by the output from an IR or an RF detector being fed into the microprocessor control circuit 9. The IR or RF detector can be arranged to feed the stimulus to the microprocessor control circuit 9 by means of an IR or RF transmitter. Cessation of the signal from the transmitter will result in cessation of the change in frequency 14 from the control circuit 9 leaving the lamp producing a constant brightness at the desired illumination level.

The method of controlling the brightness of a compact fluorescent lamp according to the invention allows the brightness of such a lamp to be controlled over a wide range without making any changes to existing lighting circuits comprising dimmers or switches. In one preferred embodiment the fluorescent tube is detachably fitted to a ballast unit which forms part of the lamp base. The ballast unit also includes a conventional supply connection such as bayonet or an ES base. By this means a compact fluorescent lamp can by fitted economically to an existing lighting circuit and replaced as required.

The principles of the invention are applicable to both compact fluorescent lamps and ordinary fluorescent lamps.

1. A method of controlling the brightness of a fluorescent lamp from a low frequency alternating current mains supply in which the lamp has an associated ballast providing a higher frequency power supply, characterized in that the ballast includes a microprocessor which controls the frequency of the power supplied to the lamp by the ballast and which is varied in accordance with the desires of the operator by actuating a cycle of variation of the frequency supplied to the lamp and ending the cycle when the desired brightness is reached.

2. The method as claimed in claim 1, characterized in that cycle of variation of the frequency is initiated by operation of a control switch located in series with the mains supply.

3. The method as claimed in claim 2, characterized in that the control switch is an on/off switch and the cycle of variation of the frequency is initiated by momentary operation of the control switch.

4. The method as claimed in claim 2, characterized in that the control switch is a dimmer switch which suppresses part of each cycle of the mains supply and the variation of the frequency is initiated by the control switch.

5. The method as claimed in claim 1, characterized in that cycle of variation of the frequency is initiated by an external radiated signal received by the microprocessor.

6. The method as claimed in claim 5, characterized in that the external radiated signal is an infrared signal directed to an IR sensor located in the ballast.

7. The method as claimed in claim 5, characterized in that the external radiated signal is a radio frequency signal directed to a radio-receiver incorporated in the ballast.

8. The method as claimed in claim 1, characterized in that the fluorescent tube is detachably fitted to a ballast unit which forms part of the lamp base.

9. Fluorescent lamp ballasts for use in the method of claim 1, comprising a microprocessor which controls the frequency of the power supplied to the lamp by the ballast and which is varied in accordance with the desires of the operator by actuating a cycle of variation of the frequency supplied to the lamp and ending the cycle when the desired brightness is reached.

10. The method as claimed in claim 2, characterized in that the fluorescent tube is detachably fitted to a ballast unit which forms part of the lamp base.

11. The method as claimed in claim 3, characterized in that the fluorescent tube is detachably fitted to a ballast unit which forms part of the lamp base.

12. The method as claimed in claim 4, characterized in that the fluorescent tube is detachably fitted to a ballast unit which forms part of the lamp base.

13. The method as claimed in claim 5, characterized in that the fluorescent tube is detachably fitted to a ballast unit which forms part of the lamp base.

14. The method as claimed in claim 6, characterized in that the fluorescent tube is detachably fitted to a ballast unit which forms part of the lamp base.

15. The method as claimed in claim 7, characterized in that the fluorescent tube is detachably fitted to a ballast unit which forms part of the lamp base.
